(19) United States
(12) Patent Application Publication
(10) Pub. No.: US 2025/0116889 A1
(43) Pub. Date: Apr. 10, 2025

(54) OPTICAL MODULATOR AND ELECTRONIC APPARATUS INCLUDING THE SAME

(71) Applicants: SAMSUNG ELECTRONICS CO., LTD., Suwon-si (KR); The Board of Trustees of the Leland Stanford Junior University, Stanford, CA (US)

(72) Inventors: Nicholas Güsken, Stanford, CA (US); Junghwan Song, Sanford, CA (US); Mark Brongersma, Stanford, CA (US); Minkyung Lee, Suwon-si (KR); Junghyun Park, Suwon-si (KR)

(73) Assignees: SAMSUNG ELECTRONICS CO., LTD., Suwon-si (KR); The Board of Trustees of the Leland Stanford Junior University, Stanford, CA (US)

(21) Appl. No.: 18/907,086

(22) Filed: Oct. 4, 2024

Related U.S. Application Data
(60) Provisional application No. 63/542,917, filed on Oct. 6, 2023.

(30) Foreign Application Priority Data
Feb. 7, 2024 (KR) 10-2024-0019176

(51) Int. Cl. G02F 1/00; G02F 1/29

(52) U.S. Cl. CPC G02F 1/0054; G02F 1/009; G02F 1/292

(57) ABSTRACT

Provided is an optical modulator including a substrate, and a plurality of unit structures periodically on the substrate, one of the plurality of unit structures including a heater layer on a first surface of the substrate, an antenna on a first surface of the heater layer, the antenna including a phase change material, a passivation layer on the substrate, the heater layer, and the antenna, and a reflector on a second surface of the substrate opposite to the first surface of the substrate.

### CROSS-REFERENCE TO RELATED APPLICATION

This application claims priority to U.S. Provisional Application No. 63/542,917, filed on Oct. 6, 2023, in the U.S. Patent and Trademark Office and Korean Patent Application No. 10-2024-0019176, filed on Feb. 7, 2024, in the Korean Intellectual Property Office, the disclosures of which are incorporated by reference herein in their entireties.

### BACKGROUND

### 1. Field

Example embodiments of the present disclosure relate to an optical modulator and an electronic apparatus including the same.

### 2. Description of the Related Art

In order to steer laser beams to desired locations, there are a method of mechanically rotating a laser irradiation portion and a method of using an optical phased array (OPA) method. Recently, methods of using an OPA method of steering laser beams by modulating and outputting phases of incident laser beams by using optical modulators have been spotlighted, and there are attempts to use meta-structures using surface plasmon resonance for optical modulators described above. Beam steering apparatuses using OPA methods may be, for example, applied to various fields, such as light detection and ranging (LiDAR) apparatuses, and three-dimensional (3D) depth cameras that acquire distance information for each direction.

### SUMMARY

One or more example embodiments provide an optical modulator and an electronic apparatus including the same.

Additional aspects will be set forth in part in the description which follows and, in part, will be apparent from the description, or may be learned by practice of the example embodiments.

According to an aspect of an example embodiment, there is provided an optical modulator including a substrate, and a plurality of unit structures periodically on the substrate, wherein one of the plurality of unit structures includes a heater layer on a first surface of the substrate, an antenna on a first surface of the heater layer, the antenna including a phase change material, a passivation layer on the substrate, the heater layer, and the antenna, and a reflector on a second surface of the substrate opposite to the first surface of the substrate.

The antenna may contact the first surface of the heater layer.

A width of the antenna in a horizontal direction may be less than a wavelength of light incident of the plurality of unit structures.

The phase change material may include Sb₂Se₃ or Sb₂S₃.

The phase change material may include Ge, Sb and Te.

A material phase of the antenna may change based on a change in a

temperature of the heater layer due to a voltage being applied to the heater layer.

A width of the heater layer may be greater than a width of the antenna in a horizontal direction.

The heater layer may include Au, Al, Ag, Cu or W.

The passivation layer may include oxide or nitride.

A thickness of the passivation layer may be 20 nm to 50 nm in a vertical direction.

The reflector may include a metal material.

The substrate may include an insulating substrate.

The plurality of unit structures may be configured to be respectively and independently driven and may be configured to steer light reflected from the optical modulator to a point based on a phase profile formed by the plurality of unit structures.

The plurality of unit structures may be one-dimensionally or two-dimensionally provided on the substrate.

According to another aspect of an example embodiment, there is provided an electronic apparatus including an optical modulator including a substrate, and a plurality of unit structures periodically on the substrate, wherein one of the plurality of unit structures includes a heater layer on a first surface of the substrate, an antenna on a first surface of the heater layer, the antenna including a phase change material, a passivation layer on the substrate, the heater layer, and the antenna, and a reflector on a second surface of the substrate opposite to the first surface of the substrate.

According to still another aspect of an example embodiment, there is provided a beam steering apparatus including a light source configured to emit a laser beam, an optical modulator configured to steer the laser beam incident from the light source, and a detector configured to detect the steered laser beam, wherein the optical modulator includes a substrate, and a plurality of unit structures periodically on the substrate, wherein one of the plurality of unit structures includes a heater layer on a first surface of the substrate, an antenna on a first surface of the heater layer, the antenna including a phase change material, a passivation layer on the substrate, the heater layer, and the antenna, and a reflector on a second surface of the substrate opposite to the first surface of the substrate.

The antenna may contact the first surface of the heater layer.

The phase change material may include Sb₂Se₃ or Sb₂S₃.

The heater layer may include Au, Al, Ag, Cu or W.

The passivation layer may include oxide or nitride.

### BRIEF DESCRIPTION OF DRAWINGS

The above and other aspects, features, and advantages of example embodiments of the disclosure will be more apparent from the following description taken in conjunction with the accompanying drawings, in which:

FIG. 1 is a perspective view schematically illustrating an optical modulator according to an example embodiment;

FIG. 2 is a perspective view illustrating a cut portion of the optical modulator illustrated in FIG. 1;

FIG. 3 is a cross-sectional view illustrating a unit structure of the optical modulator illustrated in FIG. 1;

FIG. 4 schematically illustrates an example of a unit structure according an example embodiment;

FIG. 5 illustrates a reflection phase and relative amplitude of reflected light according to a thickness ha of an amorphous layer of an antenna illustrated in FIG. 4;

FIG. 6 schematically illustrates an example of an optical modulator according to example embodiments;

FIG. 7 illustrates that a wavefront of reflected light is formed in the optical modulator illustrated in FIG. 6;

FIG. 8 illustrates an intensity for each order according to a wavelength of reflected light in the optical modulator illustrated in FIG. 6;

FIG. 9 illustrates a relationship between a thickness ha of an amorphous layer and a relative amplitude according to periodicities of unit structures in an optical modulator, according to an example embodiment;

FIG. 10 illustrates a relationship between a thickness ha of an amorphous layer and a phase according to a periodicities of unit structures in an optical modulator, according to an example embodiment;

FIG. 11 schematically illustrates a beam steering apparatus according to an example embodiment;

FIGS. 12 and 13 are conceptual views illustrating cases in which a light detection and ranging (LiDAR) apparatus is applied to a vehicle, according to example embodiments;

FIG. 14 is a block diagram illustrating a schematic structure of an electronic apparatus according to an example embodiment;

FIG. 15 is a block diagram illustrating a schematic structure of a camera module provided in the electronic apparatus of FIG. 14;

FIG. 16 is a block diagram illustrating a schematic structure of a three-dimensional (3D) sensor provided in the electronic apparatus of FIG. 14;

FIG. 17 is a block diagram illustrating a schematic structure of an electronic apparatus according to an example embodiment; and

FIG. 18 is a block diagram illustrating a schematic structure of an eye tracking sensor provided in the electronic apparatus of FIG. 17.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Hereinafter, example embodiments will be described in detail with reference to the accompanying drawings. In the following drawings, the same reference numerals refer to the same components, and the size of each component in the drawings may be exaggerated for clarity and convenience of description. Meanwhile, embodiments described below are merely illustrative, and various modifications may be made from these embodiments.

Hereinafter, those described as “above” or “on” may include those directly above, below, left, and right by contact, as well as those non-contact above, below, left, and right. The singular forms are intended to include the plural forms as well, unless the context clearly indicates otherwise. In addition, when a portion “includes” or “comprises” a component, it means that it may further include other components, rather than excluding other components, unless specifically stated to the contrary.

The use of the term “the” and similar indicative terms may correspond to both singular and plural forms. Unless there is the explicit order or contrary description of operations constituting a method, these operations may be performed in an appropriate order and are not necessarily limited to the order described.

Also, terms such as “ . . . or”, “module”, etc. used herein refer to units that process at least one function or operation, and the units may be implemented as hardware or software or as a combination of hardware and software.

In addition, connections or connecting units of lines between components shown in the drawings are examples of functional connections and/or physical or circuit connections, and may be represented as alternative or additional various functional connections, physical connections, or circuit connections in real apparatuses.

In addition, the use of all examples or example terms is simply intended to describe the technical spirit in detail, and the scope of embodiments are not limited by these examples or example terms unless they are limited by claims.

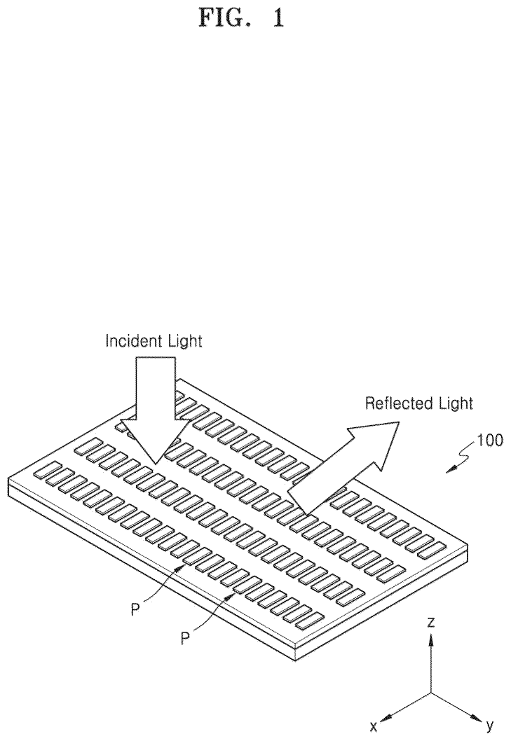

FIG. 1 is a perspective view schematically illustrating an optical modulator 100 according to an example embodiment.

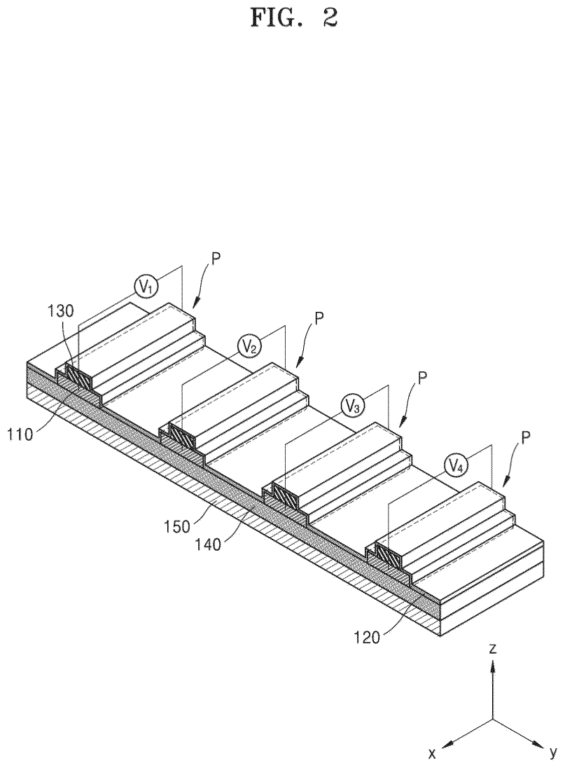

Referring to FIG. 1, the optical modulator 100 may modulate a phase of reflected light when reflecting incident light and include a plurality of unit structures P periodically arranged on a substrate 140 of FIG. 2. The plurality of unit structures P may be a meta surface. FIG. 1 illustrates that the plurality of unit structures P are arranged in a two-dimensional form. However, the plurality of unit structures P are not limited thereto and may be arranged in a one-dimensional form. As described below, the unit structures P may be respectively and independently driven to form a phase profile and steer light reflected from the optical modulator 100 in a desired direction by controlling the phase profile.

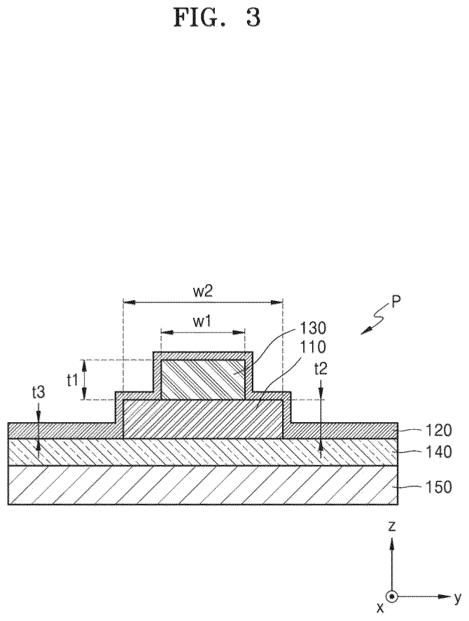

FIG. 2 is a perspective view illustrating a cut portion of the optical modulator 100 illustrated in FIG. 1. FIG. 2 illustrates that four unit structures P from among the plurality of unit structures P are provided on the substrate 140. FIG. 3 illustrates a cross-section of each unit structure P of the optical modulator 100.

Referring to FIGS. 2 and 3, the optical modulator 100 may include a plurality of heater layers 110 arranged on an upper surface of the substrate 140 at certain intervals, a plurality of antennas 130 respectively provided on the plurality of heater layers 110, a passivation layer 120 provided to cover the plurality of heater layers 110 and the plurality of antennas 130, and a reflector 150 provided on a lower surface the substrate 140 opposite to the upper surface. The heater layer 110, the antenna 130, and the passivation layer 120 provided on the substrate 140, and the reflector 150 provided on the substrate 140 may be the unit structure P of the optical modulator 100. For example, the passivation layer 120 and the reflector 150 may be respectively and continuously formed and provided in common in a plurality of unit structures P.

The substrate 140 may include an insulating material. For example, the substrate 140 may include silicon oxide (SiO₂), but is not limited thereto. The heater layer 110 may be provided on the upper surface of the substrate 140, and the antenna 130 may be provided on an upper surface of the heater layer 110. The heater layer 110 may be between the substrate 140 and the antenna 130.

The antenna 130 may include a phase change material of which phase changes according to temperature. When the temperature of the phase change material increases or decreases, the phase of the phase change material may change. For example, when the phase change material is heated to a crystallization temperature for a relatively long time, the phase change material may have a crystalline phase, and when the phase change material is heated to a melting point and then cooled quickly, the phase change material may have an amorphous phase. The phase change material may have an amorphous phase, a crystalline phase, and an intermediate phase. The phase change material may have different refractive indexes in respective phases. For example, the phase change material may have a different refractive index according to content of the amorphous phase or content of the crystalline phase.

When the temperature of the heater layer 110 changes according to a voltage applied to the heater layer 110, a phase change occurs in the phase change material. Accordingly, the refractive index of the antenna 130 including the phase change material may change, and a phase of reflected light passing through the antenna 130 may change.

The phase change material of the antenna 130 may be a material having relatively low light loss in an infrared light region, a visible region, or/or an ultraviolet region. The phase change material may include, for example, antimony triselenide (Sb₂Se₃) or antimony trisulfide (Sb₂S₃). The phase change material may also include a GST including germanium (Ge), antimony (Sb), and tellurium (Te). For example, the phase change material may include at least one of Ge₂Sb₂Te₅ and Ge₃Sb₂Te₆).

The antenna 130 may have, for example, a rectangular parallelepiped shape. However, the antenna 130 is not limited thereto and may have other shapes. For example, a cross-section of the antenna 130 may have various shapes such as a polygonal shape such as a rectangular shape or a triangular shape, a cross shape, a circular shape, and an elliptical shape. The antenna 130 may vary in size or shape thereof according to an incident wavelength.

A width w1 of the antenna 130 may be less than a wavelength of incident light. A thickness t1 of the antenna 130 may also be less than the wavelength of the incident light. The thickness t1 of the antenna 130 may be several nanometers to several hundred nanometers. For example, the thickness t1 of the antenna 130 may be formed to be several tens of nanometers or more to increase a volume in which a refractive index changes. Modulation efficiency of the optical modulator 100 may increase with an increase in the volume in which the refractive index changes.

One unit structure P may include various numbers of antennas 130. FIGS. 2 and 3 illustrate that one unit structure P includes one antenna 130, but embodiments are not limited thereto, and one unit structure P may include a plurality of antennas 130.

The heater layer 110 may be provided on a lower surface of the antenna 130. The heater layer 110 may be provided to be in contact with the lower surface of the antenna 130. An electrode may be connected to the heater layer 110, and thus, when a voltage is applied to the heater layer 110 through the electrode, the heater layer 110 and the antenna 130 adjacent thereto may rise to a certain temperature. In addition, when the application of the voltage is terminated, the temperatures of the heater layer 110 and the antenna 130 may be lowered to original temperatures. According to the voltage applied to the heater layer 110, the phase change of the phase change material may be adjusted, and accordingly, a phase of reflected light passing through the antenna 130 may be controlled.

The heater layer 110 may include, for example, gold (Au), aluminum (Al), silver (Ag), copper (Cu), or tungsten (W). As a detailed example, the heater layer 110 may include Au, which is metal having relatively low light absorption. However, the heater layer 110 is not limited thereto and may have a width w2 that is greater than the width w1 of the antenna 130. The width w2 of the heater layer 110 may be less than the wavelength of the incident light. A thickness t2 of the heater layer 110 may be less than the wavelength of the incident light.

The passivation layer 120 may be provided on the substrate 140 to cover the heater layer 110 and the antenna 130. The passivation layer 120 may be provided on side surfaces and upper surfaces of the heater layer 110 and side surfaces and upper surfaces of the antenna 130. The passivation layer 120 may be continuously formed to be commonly provided in the plurality of unit structures P. The passivation layer 120 may include various kinds of oxide or nitride. For example, the passivation layer 120 may include aluminum oxide (Al₂O₃), SiO₂, hafnium oxide (HfO₂), silicon nitride (Si₃N₄), or the like. A thickness t3 of the passivation layer 120 may be less than the wavelength of the incident light. For example, the thickness t3 of the passivation layer 120 may be about 20 nm to about 50 nm. However, embodiments are not limited thereto.

The reflector 150 may be provided on the lower surface of the substrate 140. The reflector 150 may be continuously formed to be commonly provided in a plurality of unit structures P. The reflector 150 may improve reflection efficiency of the incident light and may include a metal material having high reflection characteristics. For example, the reflector 150 may include Au, Ag, or the like, but is not limited thereto.

The unit structures P may be respectively and independently driven. For example, a plurality of voltages may be independently applied to the unit structures P (in particular, to the heater layers 110), and accordingly, different voltages may be applied to the unit structures P. FIG. 2 illustrates that four different voltages V1, V2, V3, and V4 are applied to four unit structures P.

As described above, when independent voltages are applied to the heater layers 110, the unit structures P may respectively have independent temperatures. Accordingly, a phase profile may be formed by the plurality of unit structures P by independently modulating the phase of the reflected light for each unit structure P, and the reflected light may be steered in various directions by controlling the phase profile. In the optical modulator 100, different voltages may be applied to the unit structures P so that the reflected light is steered to a particular point by forming a certain wavefront.

In the optical modulator 100 according to an example embodiment, the passivation layer 120 may be provided to surround a surface of the antenna 130 so that the surface of the antenna 130 is not exposed external to the optical modulator 100. Therefore, heat generated by the antenna 130 may be reduced from being emitted external to the optical modulator 100, and accordingly, higher concentration of heat energy may be achieved. In addition, by providing a reflector 150 under the heater layer 110, reflection efficiency may be increased by more efficiently reflecting light incident on the optical modulator 100 and a reflection phase area may be expanded.

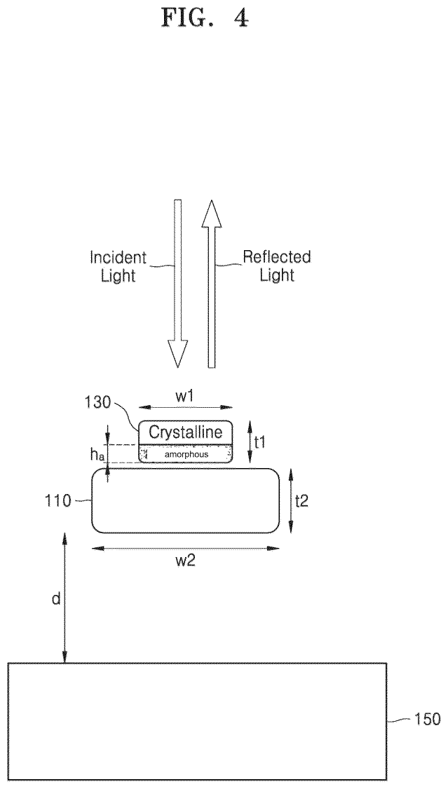

FIG. 4 schematically illustrates an example of a unit structure according to an example embodiment.

Referring to FIG. 4, an antenna 130 may be formed of Sb₂Se₃, and a width w₁ and a thickness t₁ of the antenna 130 may be 205 nm and 39 nm, respectively. A heater layer 110 may be formed of Au, and a width w₂ and a thickness t₂ of the heater layer 110 may be 273 nm and 51 nm, respectively. A reflector 150 may be formed of Au, and a distance d between the heater layer 110 and the reflector 150 may be 109 nm.

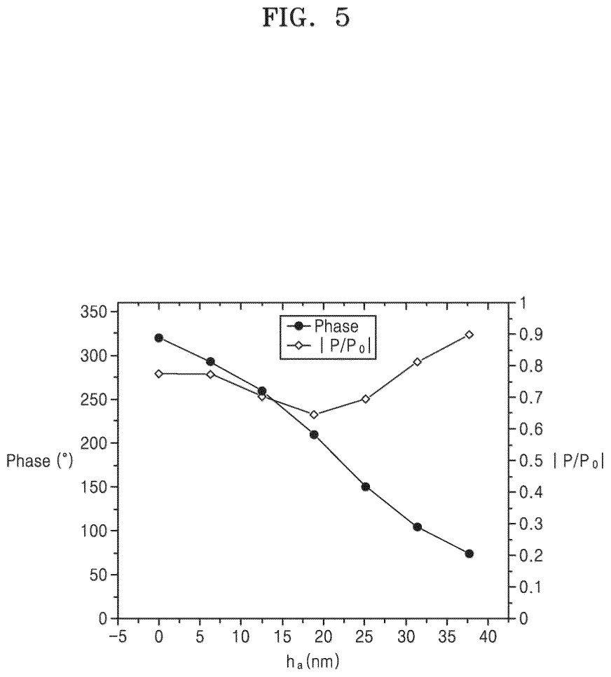

A phase change material of the antenna 130 may include an amorphous layer adjacent to the heater layer 110 and a crystalline layer formed on an upper surface of the amorphous layer. For example, the results of calculating (obtaining) a reflection phase and a relative amplitude abs (P/P₀) according to a thickness ha of the amorphous layer are shown in FIG. 5.

FIG. 5 illustrates a graph of the result of calculating reflection characteristics with respect to light having a wavelength of 940 nm, which is vertically incident on the unit structure shown in FIG. 4. For example, the relative amplitude may be defined as a ratio of an amplitude P of reflected light to an amplitude Po of incident light, i.e., abs (P/P₀).

Referring to FIG. 5, as the result of calculating the relative amplitude and a reflection phase, the reflection phase may be modulated within a range of about 250° while maintaining the amplitude at about 60% or more.

FIG. 6 schematically illustrates an example of an optical modulator according to example embodiments.

Referring to FIG. 6, the optical modulator may include 12 unit structures. A heater layer, an antenna, and a reflector of each unit structure may correspond to the unit structure shown in FIG. 4. A SiO₂ substrate may be used as a substrate, and a passivation layer, which covers the heater layer, and the antenna are formed of Al₂O₃. In addition, periodicities of the unit structures (e.g., a distance between centers of adjacent antennas) may be set to 500 nm.

The 12 unit structures may have amorphous layers of different thicknesses by controlling a voltage applied to the heater layer. For example, the 12 unit structures may be formed such that the thicknesses of the amorphous layers gradually increase from left to right. A phase change material of the leftmost unit structure may include crystalline Sb₂Se₃ (c-Sb₂Se₃), and a phase change material of the rightmost unit structure may include amorphous Sb₂Se₃ (a-Sb₂Se₃).

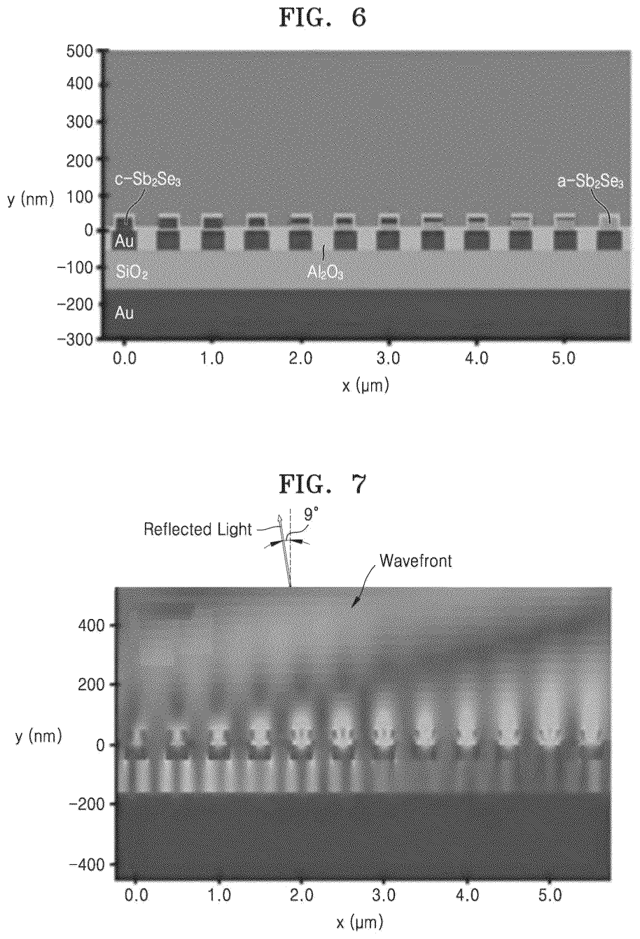

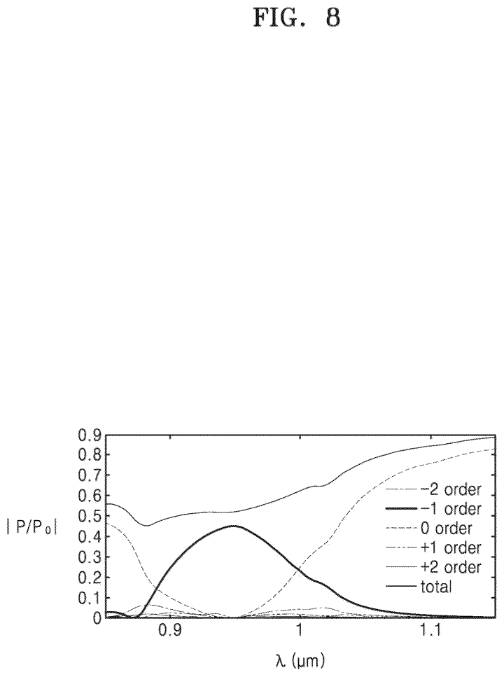

FIG. 7 illustrates that a wavefront of reflected light is formed when light having a wavelength of 940 nm is vertically incident on the optical modulator in the state shown in FIG. 6. In addition, FIG. 8 illustrates graphs of an intensity for each order according to the wavelength of the reflected light shown in FIG. 7.

Referring to FIGS. 7 and 8, reflected light may have a reflection angle of about 9°, and a 1^{st} order beam (e.g., a −1^{st} order beam on a graph) may be reflected. When analyzing components of the reflected light, a relative amplitude abs (P/P₀) of the 1^{st} order beam (e.g., the −1^{st} order beam on the graph) may be about 0.46, and a relative amplitude of a 0^{th} order beam in which offset suppression occurs may be about 0.01 or less.

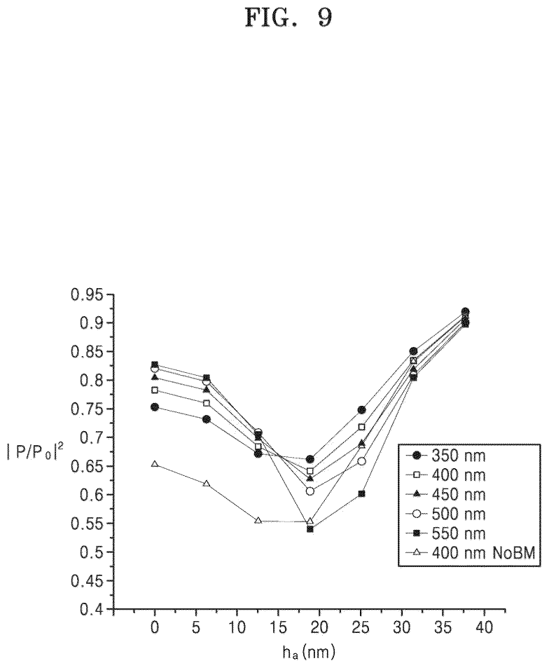

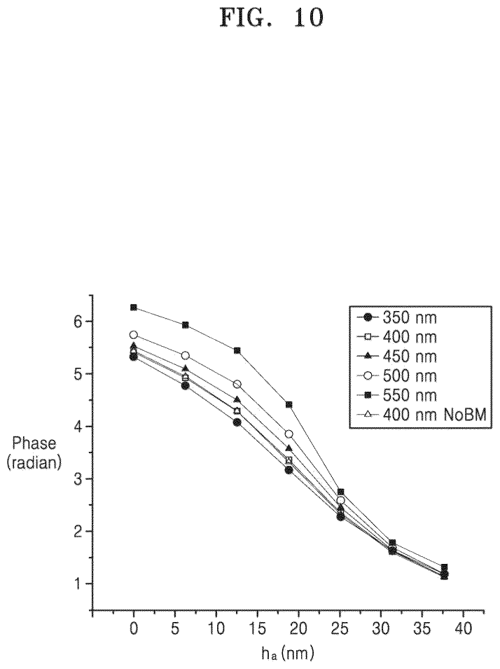

FIG. 9 illustrates a relationship between a thickness ha of an amorphous layer and a relative amplitude abs (P/P₀)² according to periodicities of unit structures in an optical modulator, according to an example embodiment. FIG. 10 illustrates a relationship between a thickness ha of an amorphous layer and a phase according to periodicities of unit structures in an optical modulator, according to an example embodiment.

As illustrated in FIGS. 9 and 10, each unit structure may correspond to the unit structure shown in FIG. 6, and periodicities of unit structures may refer to a distance between centers of adjacent antennas. As illustrated in FIG. 9, a relative amplitude may be defined as the square of a ratio of an amplitude P of reflected light to an amplitude Po of incident light, i.e., abs (P/P₀)².

FIG. 9 illustrates graphs showing a relationship between the thickness ha of the amorphous layer and the relative amplitude abs (P/P₀)²) when the periodicities of the unit structures are 350 nm, 400 nm 450 nm, 500 nm, and 550 nm, respectively. In addition, FIG. 10 illustrates the relationship between the thickness ha of the amorphous layer and the phase when the periodicities of the unit structures are 350 nm, 400 nm 450 nm, 500 nm, and 550 nm, respectively. FIGS. 9 and 10 illustrate that NoBM indicates an optical modulator that does not include a reflector.

Referring to FIGS. 9 and 10, an intensity of reflected light may be greater in an optical modulator including a reflector than in an optical modulator not including a reflector. In addition, the amount of reflection phase change may be relatively greater in the optical modulator including the reflector than in the optical modulator not including the reflector. Therefore, as in the optical modulator 100 according to an example embodiment, reflection efficiency may be increased and a reflection phase area may be expanded by providing the reflector 150 under the heater layer 110.

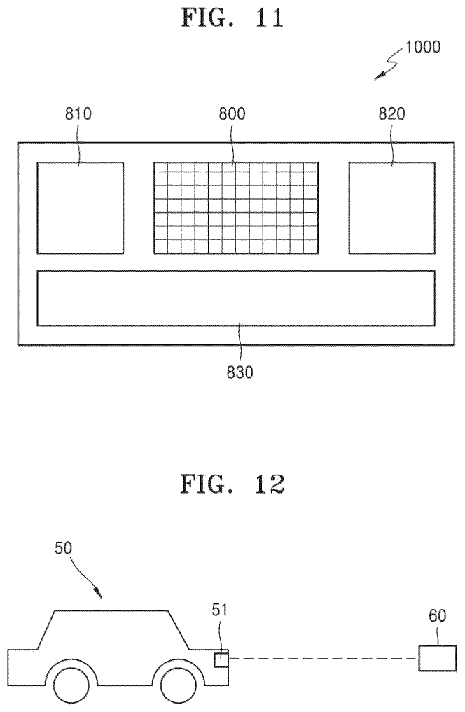

The optical modulator 100 according to an example embodiment described above may be applied to, for example, a beam steering apparatus that steers an incident laser beam in a desired direction. FIG. 11 illustrates a beam steering apparatus 1000 according to an example embodiment.

Referring to FIG. 11, the beam steering apparatus 1000 may include a laser light source 810 for emitting a laser beam of a certain wavelength, an optical modulator 800 for steering an incident laser beam through phase modulation, a detector 820 for detecting the steered laser beam, and a driving driver 830. For example, the driving driver 830 may include a driving circuit for driving the laser light source 810, the optical modulator 800, and the detector 820.

The laser light source 810 may emit, for example, a laser beam having a wavelength of about 900 nm to 1000 nm. However, the laser light source 810 is not limited thereto. The laser light source 810 may be a laser diode, but embodiments are not limited thereto. A laser beam emitted from the laser light source 810 may be incident on the optical modulator 800. The optical modulator 800 may steer the laser beam in a desired direction by modulating a phase of the incident laser beam and emitting the modulated laser beam. For example, the optical modulator 800 may be the optical modulator 100 according to the above-described example embodiment. When the laser beam steered by the optical modulator 800 is emitted to and reflected from an object, the detector 820 may detect the reflected laser beam.

The optical modulator 100 according to the example embodiment described above or the beam steering apparatus 1000 including the same may be applied to various electronic apparatuses such as a light detection and ranging (LiDAR) apparatus, a three-dimensional (3D) sensor, a 3D depth camera that acquires distance information in each direction, and a depth sensor.

In addition, the optical modulator 100 or the beam steering apparatus 1000 including the same may be mounted in an electronic apparatus such as a smartphone, a wearable device (e.g., a glass-type device that implements augmented reality (AR) and virtual reality (VR), or the like), an Internet of Things (IoT) device, a home appliance, a tablet personal computer (PC), a personal digital assistant (PDA), a portable multimedia player (PMP), a navigation system, a drone, a robot, an unmanned vehicle, an autonomous vehicle, and an advanced drivers assistance system (ADAS).

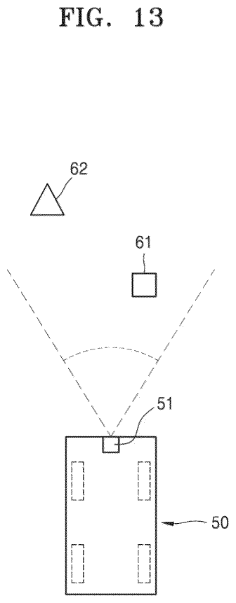

FIGS. 12 and 13 are conceptual views illustrating that a LIDAR apparatus 51 is applied to a vehicle 50, according to example embodiments.

Referring to FIGS. 12 and 13, the LiDAR apparatus 51 may be applied to the vehicle 50, and information regarding a subject 60 may be acquired by using the same. The vehicle 50 may be a vehicle having an autonomous driving function. The LiDAR apparatus 51 may detect an object or a person in a direction in which the vehicle 50 travels, i.e., the subject 60. The LiDAR apparatus 51 may include the beam steering apparatus 1000 according to the above-described example embodiment. The LiDAR apparatus 51 may measure the distance to the subject 60 by using information such as the time difference between a transmission signal and a detection signal. As illustrated in FIG. 13, the LiDAR apparatus 51 may acquire information regarding a close subject 61 and a distant subject 62 within a scanning range.

The optical modulator 100 according to an example embodiment may be applied to various electronic apparatuses, in addition to a LIDAR apparatus. For example, when using the optical modulator 100 according to an example embodiment, 3D information of a space and a subject may be acquired through scanning, and thus, the optical modulator 100 may be applied to a 3D image acquisition apparatus, a 3D camera, or the like. In addition, the optical modulator 100 may be applied to a holographic display apparatus and a structured light generation apparatus. In addition, the optical modulator 100 may be applied to various optical components/apparatuses such as various beam scanning apparatuses, hologram generation apparatuses, optical coupling apparatuses, variable focus lenses, and depth sensors. In addition, the optical modulator 100 may be applied to various fields in which a meta surface or a meta structure is used. In addition, the optical modulator 100 according to an embodiment and an electronic apparatus including the same may be applied for various purposes in various optical and electronic apparatus fields.

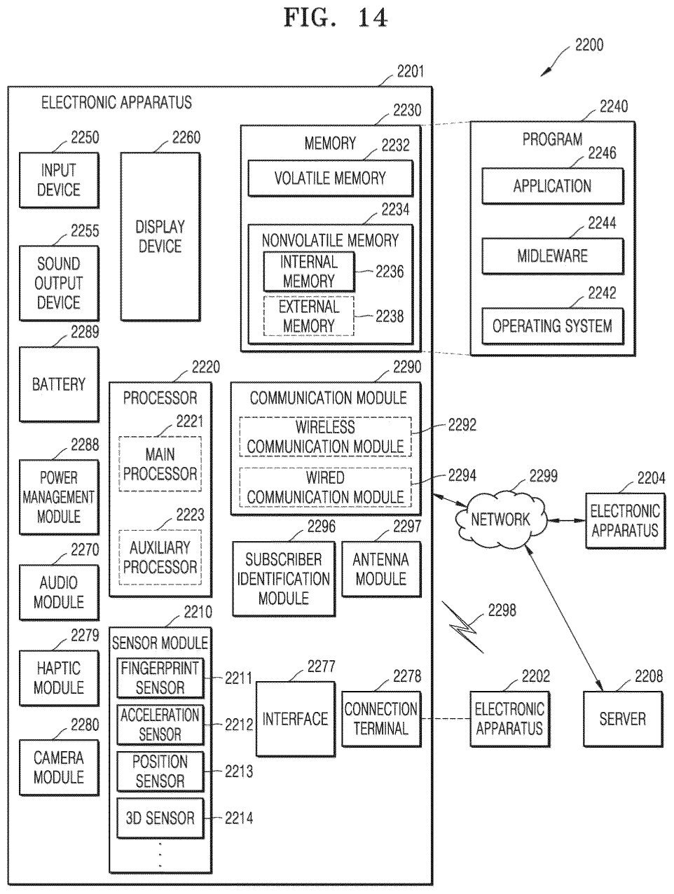

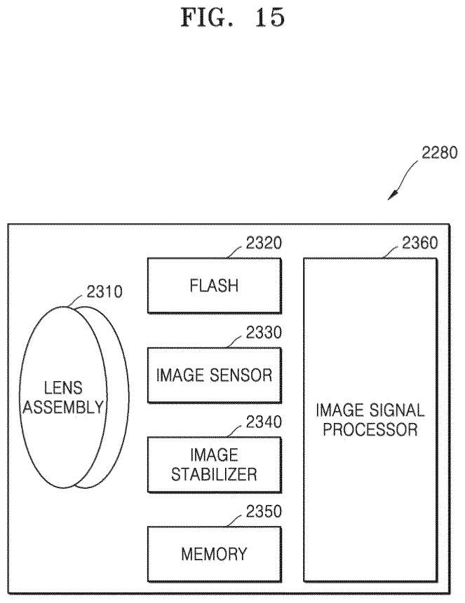

FIG. 14 is a block diagram illustrating a schematic structure of an electronic apparatus 2201 according to an example embodiment.

Referring to FIG. 14, in a network environment 2200, the electronic apparatus 2201 may communicate with another electronic apparatus 2202 through a first network 2298 (e.g., a short-range wireless communication network or the like) or may communicate with another electronic apparatus 2204 and/or a server 2208 through a second network 2299 (e.g., a long-range wireless communication network or the like). The electronic apparatus 2201 may communicate with the electronic apparatus 2204 through the server 2208. The electronic apparatus 2201 may include a processor 2220, a memory 2230, an input device 2250, a sound output device 2255, a display apparatus 2260, an audio module 2270, a sensor module 2210, an interface 2277, a haptic module 2279, a camera module 2280, a power management module 2288, a battery 2289, a communication module 2290, a subscriber identification module 2296, and/or an antenna module 2297. Some of the components (e.g., the display apparatus 2260 and the like) may be omitted from or other components may be added to the electronic apparatus 2201. Some of the components may be implemented as one integrated circuit. For example, a fingerprint sensor 2211 of an iris sensor, an illuminance sensor, or the like of the sensor module 2210 may be embedded and implemented in the display apparatus 2260 (e.g., a display or the like).

The processor 2220 may control one or a plurality of other components (e.g., hardware or software components, and the like) of the electronic apparatus 2201 by executing software (e.g., a program 2240 or the like) and may perform various types of data processing or operations. As a portion of data processing or operations, the processor 2220 may load commands and/or data received from other components (e.g., the sensor module 2210, the communication module 2290, and the like) into a volatile memory 2232, process the commands and/or data stored in the volatile memory 2232, and store result data in a nonvolatile memory 2234. The processor 2220 may include a main processor 2221 (e.g., a central processing unit, an application processor, or the like) and an auxiliary processor 2223 (e.g., a graphics processing unit, an image signal processor, a sensor hub processor, a communication processor, or the like) that may be operated independently of or together with the same. The auxiliary processor 2223 may use less power than the main processor 2221 and may perform a particularized function.

The auxiliary processor 2223 may control functions and/or states related to some of the components (e.g., the display apparatus 2260, the sensor module 2210, the communication module 2290, and the like) of the electronic apparatus 2201 on behalf of the main processor 2221 while the main processor 2221 is in an inactive state (e.g., in a sleep state) or together with the main processor 2221 while the main processor 2221 is in an active state (e.g., in an application execution state). The auxiliary processor 2223 (e.g., the image signal processor, the communication processor, or the like) may be implemented as a portion of other functionally related components (e.g., the camera module 2280, the communication module 2290, and the like).

The memory 2230 may store various types of data needed by components (e.g., the processor 2220, the sensor module 2210, and the like) of the electronic apparatus 2201. The data may include, for example, software (e.g., the program 2240 and the like) and input data and/or output data for commands related thereto. The memory 2230 may include the volatile memory 2232 and/or the nonvolatile memory 2234.

The program 2240 may be stored as software in the memory 2230 and may include an operating system 2242, middleware 2244 and/or an application 2246.

The input device 2250 may receive, from the outside (e.g., a user or the like) of the electronic apparatus 2201, a command and/or data to be used for a component (e.g., the processor 2220 or the like) of the electronic apparatus 2201. The input device 2250 may include a microphone, a mouse, a keyboard, and/or a digital pen (e.g., a stylus pen).

The sound output device 2255 may output a sound signal to the outside of the electronic apparatus 2201. The sound output device 2255 may include a speaker and/or a receiver. The speaker may be used for a general purpose, such as multimedia playback or recording playback, and the receiver may be used to receive an incoming call. The receiver may be coupled as a portion of the speaker or implemented as a separate independent device.

The display apparatus 2260 may visually provide information to the outside of the electronic apparatus 2201. The display apparatus 2260 may include a display, a hologram apparatus, or a projector and a control circuit for controlling the corresponding apparatus. The display apparatus 2260 may include touch circuitry configured to detect a touch and/or sensor circuitry (e.g., a pressure sensor) configured to measure the strength of a force generated by the touch.

The audio module 2270 may convert sound into an electrical signal or conversely convert an electrical signal into sound. The audio module 2270 may acquire sound through the input device 2250 or output sound through the sound output device 2255, and/or a speaker and/or headphone of another electronic apparatus (e.g., the electronic apparatus 2202) directly or wirelessly connected to the electronic apparatus 2201.

The sensor module 2210 may detect an operating state (e.g., power, temperature, or the like) of the electronic apparatus 2201 or an external environmental state (e.g., a user state or the like) and generate an electrical signal and/or data value corresponding to the detected state. The sensor module 2210 may include the fingerprint sensor 2211, an acceleration sensor 2212, a position sensor 2213, a 3D sensor 2214, and the like and may further include an iris sensor, a gyro sensor, an atmospheric pressure sensor, a magnetic sensor, a grip sensor, a proximity sensor, a color sensor, an infrared (IR) sensor, a biometric sensor, a temperature sensor, a humidity sensor, and/or an illuminance sensor. The 3D sensor 2214 may sense the shape, movement, and the like of an object by irradiating certain light to the object and analyzing the light reflected from the object and may include the optical modulator 100 according to the above-described example embodiment.

The interface 2277 may support one or more predefined protocols that may be used to directly or wirelessly connect the electronic apparatus 2201 to another electronic apparatus (e.g., the electronic apparatus 2202). The interface 2277 may include a high definition multimedia interface (HDMI), a universal serial bus (USB) interface, a secure digital (SD) card interface, and/or an audio interface.

A connection terminal 2278 may include a connector through which the electronic apparatus 2201 may be physically connected to another electronic apparatus (e.g., the electronic apparatus 2202 or the like). The connection terminal 2278 may include an HDMI connector, a USB connector, an SD card connector, and/or an audio connector (e.g., headphones connector or the like).

The haptic module 2279 may convert an electrical signal into a mechanical stimulus (e.g., vibration, motion, or the like) or an electrical stimulus that may be perceived by a user through a tactile or kinesthetic sense. The haptic module 2279 may include a motor, a piezoelectric element, and/or an electrical stimulation apparatus.

The camera module 2280 may capture a still image and a moving image. The camera module 2280 may include a lens assembly including one or more lenses, image sensors, image signal processors, and/or flashes. The lens assembly included in the camera module 2280 may collect light emitted from a subject that is a target of image capturing and include any one of optical modulators according to the above-described example embodiments.

The power management module 2288 may manage power supplied to the electronic apparatus 2201. The power management module 2288 may be implemented as a portion of a power management integrated circuit (PMIC).

The battery 2289 may supply power to the components of the electronic apparatus 2201. The battery 2289 may include a non-rechargeable primary battery, a rechargeable secondary battery, and/or a fuel cell.

The communication module 2290 may support establishment of a direct (wired) communication channel and/or a wireless communication channel between the electronic apparatus 2201 and another electronic apparatus (e.g., the electronic apparatus 2202, the electronic apparatus 2204, the server 2208, or the like) and performance of communication through the established communication channel. The communication module 2290 may include one or more communication processors that are operated independently of the processor 2220 (e.g., an application processor or the like) and support direct communication and/or wireless communication. The communication module 2290 may include a wireless communication module 2292 (e.g., a cellular communication module, a short-range wireless communication module, a global navigation satellite system (GNSS) communication module, or the like) and/or a wired communication module 2294 (e.g., a local area network (LAN) communication module, a power line communication module, or the like). From among the communication modules, the corresponding communication module may communicate with another electronic apparatus through the first network 2298 (e.g., a short-range communication network such as Bluetooth, WiFi Direct or infrared data association (IrDA)) or the second network 2299 (e.g., a long-range communication network such as a cellular network, the Internet, or a computer network (e.g., an LAN, a WAN, or the like)). Various types of communication modules described above may be integrated into one component (e.g., a single chip) or implemented as a plurality of separate components (e.g., a plurality of chips). The wireless communication module 2292 may identify and authenticate the electronic apparatus 2201 within a communication network such as the first network 2298 and/or the second network 2299 by using subscriber information (e.g., an international mobile subscriber identifier (IMSI) or the like) stored in the subscriber identification module 2296.

The antenna module 2297 may transmit or receive a signal and/or power to or from the outside (e.g., another electronic apparatus). An antenna may include a radiator having a conductive pattern formed on a substrate (e.g., a printed circuit board (PCB) or the like). The antenna module 2297 may include one or a plurality of antennas. When the plurality of antennas are included in the antenna module 2297, an antenna, which is appropriate for a communication method used in a communication network such as the first network 2298 and/or the second network 2299, may be selected from among the plurality of antennas by the communication module 2290. A signal and/or power may be transmitted or received between the communication module 2290 and another electronic apparatus via the selected antenna. In addition to the antenna, another component (e.g., a radio frequency integrated circuit (RFIC) or the like) may be included as a portion of the antenna module 2297.

Some of the components may be connected to one another and exchange a signal (e.g., a command, data, or the like) between peripheral apparatuses through a communication method (e.g., a bus, general purpose input and output (GPIO), a serial peripheral interface (SPI), a mobile industry processor interface (MIPI) or the like).

The command or data may be transmitted or received between the electronic apparatus 2201 and the external electronic apparatus (the electronic apparatus 2204) through the server 2208 connected to the second network 2299. The electronic apparatuses 2202 and 2204 may be the same or different types of apparatuses as or from the electronic apparatus 2201. All or some of operations executed by the electronic apparatus 2201 may be executed in one or more of the other electronic apparatuses (e.g., the electronic apparatus 2202, the electronic apparatus 2204, and the server 2208). For example, when the electronic apparatus 2201 needs to perform a certain function or service, the electronic apparatus 2201 may request one or more other electronic apparatuses to perform a portion or all of the function or service, instead of autonomously executing the function or service. The one or more other electronic apparatuses, which receive the request, may execute an additional function or service related to the request and transmit a result of the execution to the electronic apparatus 2201. To this end, cloud computing, distributed computing, and/or client-server computing technologies may be used.

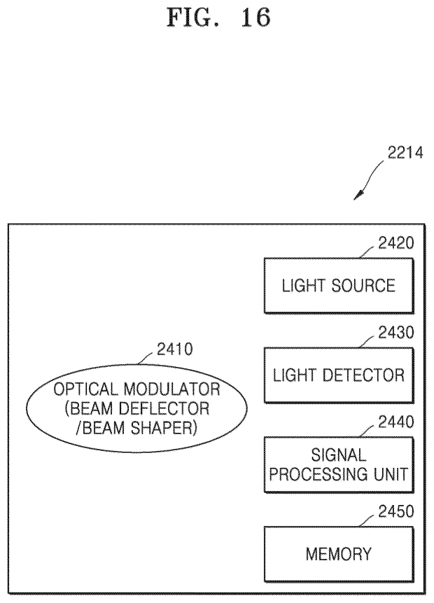

FIG. 15 is a block diagram illustrating a schematic structure of the camera module 2280 provided in the electronic apparatus 2201 of FIG. 14.

Referring to FIG. 15, the camera module 2280 may include a lens assembly 2310, a flash 2320, an image sensor 2330, an image stabilizer 2340, a memory 2350 (e.g., a buffer memory or the like), and/or an image signal processor 2360. The lens assembly 2310 may collect light emitted from a subject that is a target of image capturing and may include any one of optical modulators as described above. The lens assembly 2310 may include one or more refractive lenses and an optical modulator. The optical modulator provided therein may be designed as a lens that has a certain phase profile and includes a compensation structure to reduce phase discontinuity. The lens assembly 2310 having such a phase modulator implements desired optical performance and may have a short optical field.

The camera module 2280 may further include an actuator. The actuator may, for example, drive locations of lens elements constituting the lens assembly 2310 and adjust separation distances among the lens elements, for zooming and/or auto focus (AF).

The camera module 2280 may also include a plurality of lens assemblies 2310, and in this case, the camera module 2280 may be a dual camera, a 360-degree camera, or a spherical camera. Some of the plurality of lens assemblies 2310 may have the same lens attributes (e.g., an angle of view, focal length, autofocus, F number, optical zoom, and the like) or may have different lens attributes. The lens assembly 2310 may include a wide-angle lens or a telephoto lens.

The flash 2320 may emit light used to increase light emitted or reflected from a subject. The flash 2320 may include one or more light-emitting diodes (LEDs) (e.g., red-green-blue (RGB) LEDs, white LEDs, infrared LEDs, Ultraviolet LEDs, and the like) and/or a Xenon lamp. The image sensor 2330 may acquire an image corresponding to the subject by converting, into an electrical signal, light emitted or reflected from the subject and transmitted through the lens assembly 2310. The image sensor 2330 may include one or a plurality of sensors selected from among image sensors having different attributes, such as an RGB sensor, a black and white (BW) sensor, an IR sensor, and a UV sensor. Each of the sensors included in the image sensor 2330 may be implemented as a charged coupled device (CCD) sensor and/or a component metal oxide semiconductor (CMOS) sensor.

In response to movement of the camera module 2280 or the electronic apparatus 2201 including the same, the image stabilizer 2340 may allow a negative effect due to the movement to be compensated for by moving one or the plurality of lenses or the image sensors 2330 included in the lens assembly 2310 in a particular direction or controlling operating characteristics of the image sensor 2330 (e.g., adjusting read-out timing or the like). The image stabilizer 2340 may detect the movement of the camera module 2280 or the electronic device 2201 by using a gyro sensor (not shown) or an acceleration sensor (not shown) arranged inside or outside the camera module 2280. The image stabilizer 2340 may be optically implemented.

The memory 2350 may store, for a next image processing operation, some or all data of the image acquired through the image sensor 2330. For example, when a plurality of images are acquired at a high speed, acquired original data (e.g., Bayer-patterned data, high-resolution data, or the like) may be stored in the memory 2350 and used to display only a low-resolution image and then transmit original data of a selected (e.g., user-selected or the like) image to the image signal processor 2360. The memory 2350 may be integrated into the memory 2230 of the electronic apparatus 2201 or may be configured as a separate memory operated independently.

The image signal processor 2360 may perform one or more types of image processing on the image acquired through the image sensor 2330 or the image data stored in the memory 2350. The one or more types of image processing may include depth map generation, 3D modeling, panorama generation, feature point extraction, image synthesis, and/or image compensation (e.g., noise reduction, resolution adjustment, brightness adjustment, blurring, sharpening, softening, or the like). The image signal processor 2360 may perform control (e.g., exposure time control, readout timing control, or the like) on components (e.g., the image sensor 2330 and the like) included in the camera module 2280. The image processed by the image signal processor 2360 may, for further processing, be stored back in the memory 2350 or provided to an external component (e.g., the memory 2230, the display apparatus 2260, the electronic apparatus 2202, the electronic apparatus 2204, the server 2208, or the like) of the camera module 2280. The image signal processor 2360 may be integrated into the processor 2220 or may be configured as a separate processor operated independently of the processor 2220. When the image signal processor 2360 is configured as a processor separate from the processor 2220, the image processed by the image signal processor 2360 may be displayed on the display apparatus 2260 after undergoing additional image processing by the processor 2220.

The electronic device 2201 may include a plurality of camera modules 2280 having different attributes or functions, respectively. Here, one of the plurality of camera modules 2280 may be a wide-angle camera and the other one may be a telephoto camera. Similarly, one of the plurality of camera modules 2280 may be a front camera and the other one may be a rear camera.

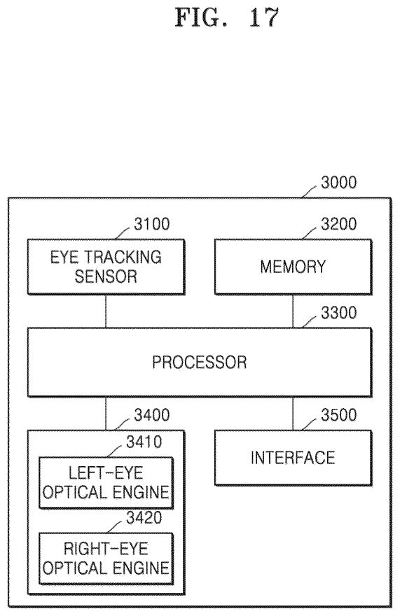

FIG. 16 is a block diagram illustrating a schematic structure of the 3D sensor 2214 provided in the electronic apparatus 2201 of FIG. 14.

Referring to FIG. 16, the 3D sensor 2214 may irradiate certain light to an object, receive and analyze the light reflected from the object, and sense the shape, movement, and the like of the object. The 3D sensor 2214 may include a light source 2420, an optical modulator 2410, a light detector 2430, a signal processing unit 2440, and a memory 2450. The optical modulator 100 according to the above-described example embodiment may be employed as the optical modulator 2410, and a target phase delay profile may be set so that the optical modulator 2410 functions as a beam deflector or a beam shaper.

The light source 2420 may irradiate light to be used for analyzing the shape or position of the object. The light source 2420 may include a light source that generates and irradiates light having a certain wavelength. The light source 2420 may include a light source, such as a laser diode (LD), an LED, and a super luminescent diode (SLD), which generates and irradiates light of a wavelength band appropriate for analysis of the position and shape of the object, e.g., light of an infrared band wavelength. The light source 2420 may be a tunable wavelength laser diode. The light source 2420 may generate and irradiate light in a plurality of different wavelength bands. The light source 2420 may generate and irradiate pulsed light or continuous light.

The optical modulator 2410 may modulate the light irradiated from the light source 2420 and transmit the modulated light to the object. When the optical modulator 2410 is a beam deflector, the optical modulator 2410 may deflect incident light in a certain direction and direct the deflected light toward the object. When optical modulator 2410 is a beam shaper, the optical modulator 2410 may modulate the incident light so that the incident light has a distribution having a certain pattern. The optical modulator 2410 may also form structured light appropriate for 3D shape analysis.

The light detector 2430 may receive reflected light of light passing through the optical modulator 2410 and irradiated to the object. The light modulator 2430 may include an array of a plurality of sensors that sense light or may include only one sensor.

The signal processing unit 2440 may analyze the shape or the like of the object by processing a signal sensed by the light detector 2430. The signal processing unit 2440 may analyze a 3D shape including a depth position of the object. For the analysis of the 3D shape of the object, a calculation for measuring the optical time of flight may be performed. Various types of calculation methods may be used to measure the optical time of flight. For example, a direct time measurement method may obtain a distance by projecting pulsed light onto an object and measuring, by using a timer, the time for which the light is reflected from the object and returns. Correlation may project pulsed light onto an object and measure a distance from brightness of reflected light that is reflected from the object and returns. A phase delay measurement method may refer to a method of projecting continuous wave light such as sine waves onto an object, detect the phase difference of reflected light that is reflected and returns, and convert the phase difference into a distance.

When structured light is irradiated onto the object, the depth position of the object may be calculated from a pattern change of the structured light reflected from the object, i.e., the result of comparison with incident structured light pattern. Depth information of the object may be extracted by tracking a pattern change for each coordinate of the structured light reflected from the object, and 3D information related to the shape, movement, and the like of the object may be extracted from the same.

The memory 2450 may store a program and other data needed for the calculation by the signal processing unit 2440. The result of calculation by the signal processing unit 2440, i.e., information regarding the shape and position of the object, may be transmitted to another unit within the electronic apparatus 2200 or another electronic apparatus. For example, the information may be used in the application 2246 stored in the memory 2230. The other electronic apparatus to which the result is transmitted may be a display apparatus or a printer that outputs the result. In addition, the other electronic apparatus may be an autonomous driving apparatus, such as an unmanned vehicle, an autonomous vehicle, a robot, or a drone, a smartphone, a smart watch, a mobile phone, a PDA, a laptop, a PC, various wearable devices, other mobile or non-mobile computing apparatuses, and an IoT device, but is not limited thereto.

FIG. 17 is a block diagram illustrating a schematic structure of an electronic device 3000 according to an example embodiment.

Referring to FIG. 17, the electronic device 3000 may be an AR device. For example, the electronic device 3000 may be a glasses-type AR device. The electronic device 3000 may include a display engine 3400, a processor 3300, an eye tracking sensor 3100, an interface 3500, and a memory 3200.

The processor 3300 may control the overall operation of the AR device including the display engine 3400 by driving an operating system or an application program and may perform various types of data processing and operations including image data. For example, the processor 300 may image data including a left-eye virtual image and a right-eye virtual image rendered to have binocular disparity.

The interface 3500 may be an interface through which data or a manipulation command is input from and output to the outside and may include, for example, a user interface such as a touch pad, controller, or operation button that may be manipulated by a user. The interface 3500 may include a wired communication module such as a USB module or a wireless communication module such as Bluetooth and may receive user manipulation information or virtual image data transmitted from an interface included in an external device through the wired and wireless communication modules.

The memory 3200 may include an internal memory such as a volatile memory or a nonvolatile memory. The memory 3200 may store various types of data, programs, or applications for driving and controlling the AR device under control by the processor 3300, and data of an input/output signal or a virtual image.

The display engine 3400 may be configured to generate light of a virtual image by receiving image data generated by the processor 3300 and may include a left-eye optical engine 3410 and a right-eye optical engine 3420. Each of the left-eye optical engine 3410 and the right-eye optical engine 3420 may include a light source that outputs light and a display panel that forms a virtual image by using light output from the light source and have the same function as a small projector. The light source may be implemented, for example, as an LED, and the display panel may be implemented as, for example, liquid crystal on silicon (LCoS).

The eye tracking sensor 3100 may be mounted at a position at which the pupil of the user wearing the AR device may be tracked and transmit a signal corresponding to gaze information of the user to the processor 3300. The eye tracking sensor 3100 may detect gaze information such as a gaze direction in which eyes of the user are directed, pupil positions of the eyes of the user, or center point coordinates of the pupils. The processor 3300 may determine an eye movement form on the basis of the gaze information of the user detected by the eye tracking sensor 3100. For example, the processor 3300 may determine, on the basis of the gaze information acquired from the eye tracking sensor 3100, various types of gaze movements including a fixation at which any one point is gaze at, a pursuit of a moving object, a saccade in which a gaze moves quickly from one gaze point to another, and the like.

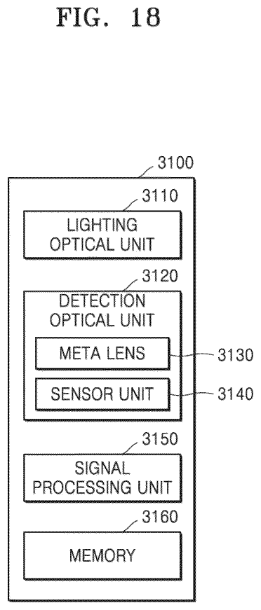

FIG. 18 is a block diagram illustrating a schematic structure of the eye tracking sensor 3100 provided in the electronic device 3000 of FIG. 17.

The eye tracking sensor 3100 may include a lighting optical unit 3110, a detection optical unit 3120, a signal processing unit 3150, and a memory 3160. The lighting optical unit 3110 may include a light source that irradiates light, e.g., infrared light, at a position of an object (an eye of a user). The detection optical unit 3120 may detect reflected light and include a meta lens 3130 and a sensor unit 3140. The signal processing unit 3150 may calculate a pupil position of the eye of the user from the result sensed by the detection optical unit 3120.

The optical modulator 100 according to the above-described example embodiment or a modified example may be used as the meta lens 3130. The meta lens 3130 may focus light from an object onto the sensor unit 3140. In the eye tracking sensor 3100 that is located very close to the eye of the user, an incidence angle of light incident on the sensor unit 3140 may be, for example, 30 degrees or more. The meta lens 3130 may have a structure having a compensation area, and reduce efficiency degradation even for light having a great incidence angle. Therefore, the accuracy of eye tracking may be increased.

The electronic device 3000 may be used as a VR device as well as an AR device and track a gaze of the user on a VR image provided from the device.

In an optical modulator according to an example embodiment, a passivation layer may be provided to surround a surface of an antenna so that the surface of the antenna is not exposed to the outside, and thus, heat generated from the antenna may be reduced from being emitted to the outside, and accordingly, concentration of heat energy may be achieved. In addition, by providing a reflector under a heater layer, reflection efficiency may be increased by more efficiently reflecting light incident on the optical modulator, and a reflection phase area may be expanded.

Although an optical modulator described above and an electronic apparatus including the same have been described with reference to example embodiments shown in the drawings but are only examples, one of ordinary skill in the art may understand that various modifications and other equivalent embodiments may be made therefrom. It should be understood that example embodiments described herein should be considered in a descriptive sense only and not for purposes of limitation. Descriptions of features or aspects within each example embodiment should typically be considered as available for other similar features or aspects in other embodiments.

While example embodiments have been described with reference to the figures, it will be understood by those of ordinary skill in the art that various changes in form and details may be made therein without departing from the spirit and scope as defined by the following claims and their equivalents.

What is claimed is:

1. An optical modulator comprising:
a substrate; and
a plurality of unit structures periodically on the substrate, wherein one of the plurality of unit structures comprises:
a heater layer on a first surface of the substrate;
an antenna on a first surface of the heater layer, the antenna comprising a phase change material;
a passivation layer on the substrate, the heater layer, and the antenna; and
a reflector on a second surface of the substrate opposite to the first surface of the substrate.

2. The optical modulator of claim 1, wherein the antenna contacts the first surface of the heater layer.

3. The optical modulator of claim 1, wherein a width of the antenna in a horizontal direction is less than a wavelength of light incident of the plurality of unit structures.

4. The optical modulator of claim 1, wherein the phase change material comprises Sb₂Se₃ or Sb₂S₃.

5. The optical modulator of claim 1, wherein the phase change material comprises Ge, Sb and Te.

6. The optical modulator of claim 1, wherein a material phase of the antenna changes based on a change in a temperature of the heater layer due to a voltage being applied to the heater layer.

7. The optical modulator of claim 1, wherein a width of the heater layer is greater than a width of the antenna in a horizontal direction.

8. The optical modulator of claim 1, wherein the heater layer comprises Au, Al, Ag, Cu or W.

9. The optical modulator of claim 1, wherein the passivation layer comprises oxide or nitride.

10. The optical modulator of claim 1, wherein a thickness of the passivation layer is 20 nm to 50 nm in a vertical direction.

11. The optical modulator of claim 1, wherein the reflector comprises a metal material.

12. The optical modulator of claim 1, wherein the substrate comprises an insulating substrate.

13. The optical modulator of claim 1, wherein the plurality of unit structures are configured to be respectively and independently driven and are configured to steer light reflected from the optical modulator to a point based on a phase profile formed by the plurality of unit structures.

14. The optical modulator of claim 1, wherein the plurality of unit structures are one-dimensionally or two-dimensionally provided on the substrate.

15. An electronic apparatus comprising:
an optical modulator comprising:
a substrate; and
a plurality of unit structures periodically on the substrate, wherein one the plurality of unit structures comprises:
a heater layer on a first surface of the substrate;
an antenna on a first surface of the heater layer, the antenna comprising a phase change material;
a passivation layer on the substrate, the heater layer, and the antenna; and
a reflector on a second surface of the substrate opposite to the first surface of the substrate.

16. A beam steering apparatus comprising:
a light source configured to emit a laser beam;
an optical modulator configured to steer the laser beam incident from the light source; and
a detector configured to detect the steered laser beam,
wherein the optical modulator comprises:
a substrate; and
a plurality of unit structures periodically on the substrate, wherein one of the plurality of unit structures comprises:
a heater layer on a first surface of the substrate;
an antenna on a first surface of the heater layer, the antenna comprising a phase change material;
a passivation layer on the substrate, the heater layer, and the antenna; and
a reflector on a second surface of the substrate opposite to the first surface.

17. The beam steering apparatus of claim 16, wherein the antenna contacts the first surface of the heater layer.

18. The beam steering apparatus of claim 16, wherein the phase change material comprises Sb₂Se₃ or Sb₂S₃.

19. The beam steering apparatus of claim 16, wherein the heater layer comprises Au, Al, Ag, Cu or W.

20. The beam steering apparatus of claim 16, wherein the passivation layer comprises oxide or nitride.
